(19) United States
(12) Patent Application Publication
(10) Pub. No.: US 2025/0104114 A1
(43) Pub. Date: Mar. 27, 2025

(54) SYSTEMS AND METHODS FOR LOCALIZING ADVERTISEMENTS AND AUTOMATED DECISIONS

(71) Applicant: Natural Concepts Marketing Group, DBA Ad Leverage

(72) Inventors: Andrew Palosi, Thousand Oaks, CA (US); Vijay Singh, Reseda, CA (US); Brianna Skiffington, Winter Garden, FL (US)

(21) Appl. No.: 18/372,801

(22) Filed: Sep. 26, 2023

(51) Int. Cl. G06Q 30/0251

(52) U.S. Cl. CPC G06Q 30/0261; G06Q 30/0252; G06Q 30/0259

(57) ABSTRACT

Disclosed is an approach for localizing advertisements and advertising decisions based on dynamic and static variables tied to location data. The system includes a computing device in operable connection with a network and an application server in operable communication with the user network to host an application program for providing a system localizing advertisements and automated decisions. The application program includes a user interface module for providing access to the application program through the user computing device. A first computer program receives at least one of the following: static variables, dynamic variables, and client specific variables. An advertisement localization system includes a computer program to interact with a dynamic campaign leveraging ad customization data feed and a static campaign generated from the static information. A decision automation system includes a computer program to receive one or more human defined decisions and one or more AI learned decisions.

### TECHNICAL FIELD

The embodiments generally relate to computerized systems and methods for localizing advertisements and automated decisions.

### BACKGROUND

To increase customer interactions and sales, many businesses develop and implement advertising campaigns to raise awareness of the business and its services. Historically, this has been accomplished using printed advertisements in local publishing outlets, video advertisements aimed at local consumers, among others. As the internet and world wide web have increased global connectivity, many businesses can connect with consumers around the world. However, depending on the business model, some businesses either prefer or are required to perform their services or sell their goods to local consumers. In such, targeted local ads remain an important aspect of marketing for many businesses.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to an approach for localizing advertisements and advertising decisions based on dynamic and static variables tied to location data. The system includes a computing device in operable connection with a network and an application server in operable communication with the user network to host an application program for providing a system localizing advertisements and automated decisions. The application program includes a user interface module for providing access to the application program through the user computing device. A first computer program receives at least one of the following: static variables, dynamic variables, and client specific variables. An advertisement localization system includes a computer program to interact with a dynamic campaign leveraging ad customization data feed and a static campaign generated from the static information. A decision automation system includes a computer program to receive one or more human defined decisions and one or more AI learned decisions.

A method for localizing advertisements and automated decisions is disclosed. A computer program receives at least one of the following: one or more static variables, one or more dynamic variables, and one or more client specific variables. Advertisements are then localized via a second computer program, which interacts with a dynamic campaign leveraging ad customization data and a static campaign generated from the static information. The receptions of one or more human defined decisions and one or more AI learned decisions is then automated.

In one aspect, the one or more static variables are received from a public database.

In one aspect, the one or more static variables are received from a private database.

In one aspect, the one or more statis variables includes at least one of the following: a target location, a city name, an electrical utility, and an area code.

In one aspect, the one or more dynamic variables includes a weather API.

In one aspect, the one or more client specific variables includes at least one of the following: an inventory and a traffic data point.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a block diagram of the computer program communicating with the static variables compiled from public or private databases, dynamic variables, and client specific variables, according to some embodiments;

FIG. 4 illustrates a block diagram of the computer program communicating with the dynamic campaign leveraging and customization feed and the static campaign generated form data feed static information, according to some embodiments; and

FIG. 5 illustrates a block diagram of the computer program communicating with human defined decisions and AI learned decisions.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

Some embodiments of the present invention are directed to a method of displaying advertisements (made up of text, numbers, URLs, images or video) that appear to be more local in nature, by either building out static campaign structures to facilitate this strategy or dynamic data feeds. This localization could be by way of including a zip code, neighborhood, city name, county name, state, voting district, area code, utility provider, government representatives, exchange rates, offers, distance, traffic, shipping time, nearest store, inventory, weather or anything with a geographic correlation that can be catalogued or pulled from an API. Further these may be scraped from the web and referenced in a database to feed into static or dynamic advertisements.

In some embodiments, for example, if a person searches Google for “Solar Company Near Me”, based on the location targeting of the campaign, and that person's determined location via the ad platform determining their location based off of their geolocation data (such as IP addresses, internet access points, GPS, satellite or beacons), their location would match to a target in an ad customizer feed. This ad customizer feed could dynamically display an advertisement with preselected corresponding variables. An example of what that might look like in manifest could be “{Palm Springs} #1 Solar Company|Save On Your {SCE} Utility Bill”.

In some embodiments, for example, if a person searches Google for “AC Repair 90231”, based on the keyword indicating location of interest rather than that person's geolocation data, their search may match a keyword in a static campaign. This may be grouped in such a way that regardless of their present location, their intended location could display in an advertisement with preselected corresponding variables. This above example would not limit the ability to also be paired with dynamic variables. An example of what that might look like in manifest could be “AC Repair In {Culver City}|{27 Minutes} Away With Traffic” and correspond with a 310 area code phone number extension.

In some embodiments, for example, if a person is browsing on Facebook, and matches a targeted audience which meets the location criteria, based off of their determined location via the ad platform determining their location based off of their geolocation data (such as IP addresses, internet access points, GPS, satellite or beacons), their location would match to a set of ads that are specific to their location. An example of what that might look like in manifest could be an image of a New England style home with corresponding ad text that says, “Custom Homes Built for Boston, Starting At $299,999”.

In some embodiments, the present invention solves the problem of localized campaign creation being limited to becoming only as granular as a human deems efficient to build them. This often leads to ad localization stopping at the DMA level, such as “Los Angeles”, rather than being drilled down to a one of hundreds of cities that are within that area, due to the time it would take to manually correlate zip codes to cities to ad groups by a human into static campaigns. Or the time it would take to create advertisement friendly data feeds that take a targeted user location such as “90210, California, United States” and turn it into something more readable and relatable like “Beverly Hills”. The present invention also solves the problem of this data being publicly available but unconsolidated. For instance, the United States Postal Service may have a database of Zip Codes and their corresponding City names. However, it may not pair them with other localized data such as their corresponding area codes or present the ability to create custom calculations such as distance from or pull live calculations such as traffic to.

Additionally, in some embodiments the system may not only create dynamic data feeds to insert variables into advertisements when that capability is available, but also has the ability to proliferate the unchanging variables into static campaign and ad structures based on either user location or target local keyword, for any platform that can determine user location.

In some embodiments, the database of information used for localization may also present the opportunities for campaign adjustments based on the information within. For example, if the weather in an area is above 100 degrees, an HVAC company may want to bid higher in that area. Or if a congressional district skews conservative, a solar company may want to bid lower. Or if traffic renders a commute to a city >2 hours, an emergency service company may want to pause advertisements in that area altogether until traffic clears. Or if the viewer's nearest store is out of a certain item, the franchiser may want to discontinue ads for that item until it is restocked. This program can set rules and subsequent actions by area.

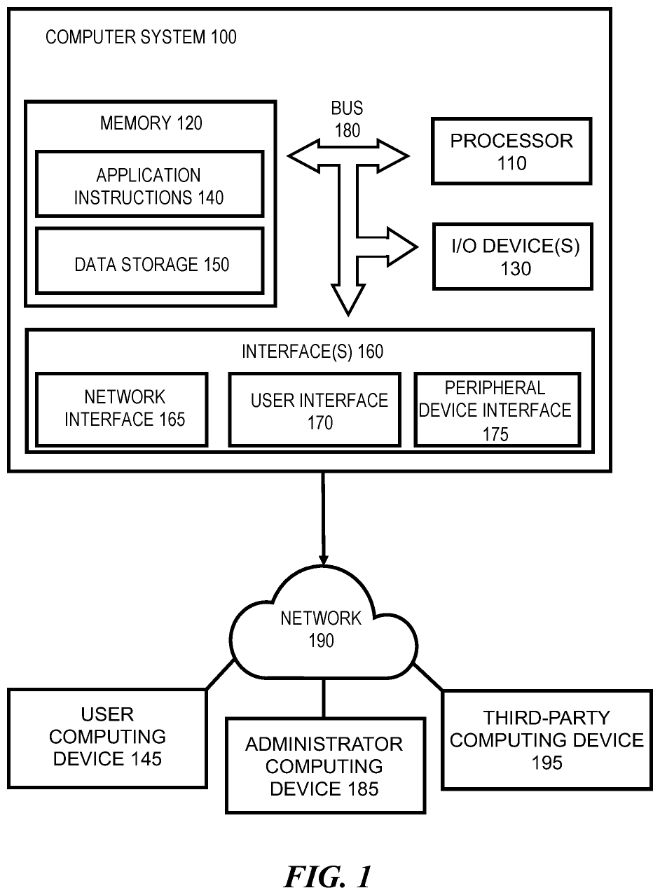

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state- setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by any user associated with the application program and computing system. The administrator computing device 185 may include users having administrative functions, or by managers and/or executives of the enterprise. The third-party computing device 195 may be utilized by third parties to receive communications from the user computing device and/or administrative computing device 185, to transmit communications to the user via the network, and otherwise interact with the various functionalities of the system. In one example, the third-party computing device may be in communication with a CRM system.

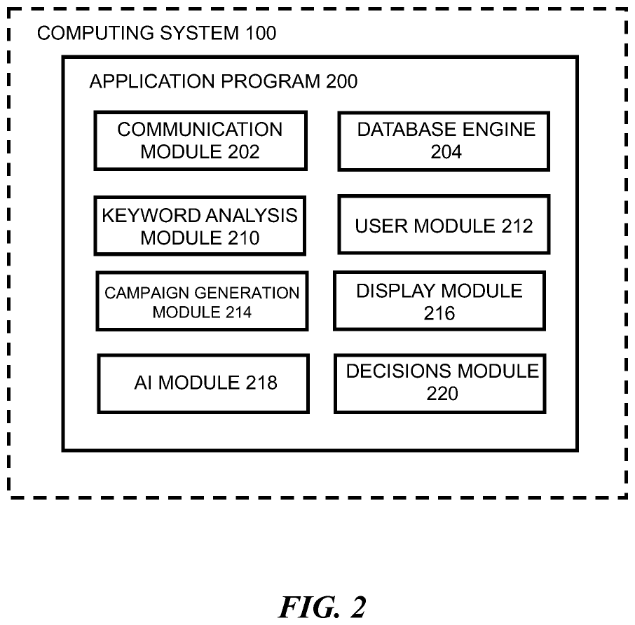

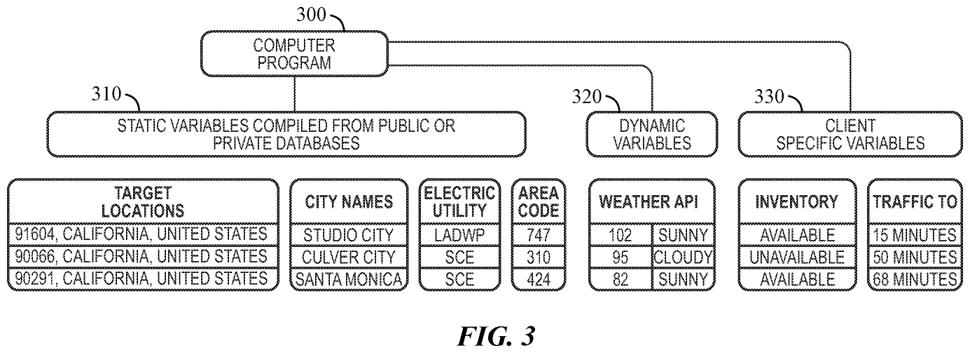

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a keyword analysis module 210, a user module 212, a campaign generation module 214, a display module 216, an AI module 218, and a decision module 220.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

In some embodiments, the keyword analysis module 210 is configured to analyze keywords input by the user including target locations, city names, electric utilities, area code, weather, inventory, traffic, and the like.

In some embodiments, the user module 212 facilitates the creation of a user account for the application system. The user module 212 may allow the user to create user preferences, establish user credentials, set user goals related to the enterprise, define the user's role within the enterprise, etc.

In some embodiments, the campaign generation module 214 is configured to generate dynamic campaign leveraging ad customization feeds including ad groups, keywords, and ad text. Further the campaign generation module 214 is configured to generate static campaign generated from data feeds static information including ad groups, keywords, ad text, etc.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the AI module 218 is configured to interpret user input and variable to adjust budget percentages, bid percentages, status, etc. In some embodiments, the decisions module 220 interprets potential input rules from humans, combining location data with variables to establish a set of rules. Potential learned decisions may be based on digested performance of variables by artificial intelligence in addition to platform held KPIs based on location, to seek patterns and calculate adjustments based on information database's variable performance.

FIG. 3 illustrates a block diagram of the computer program, statis variables compiles from public or private databases and dynamic variables. Block 300 illustrates a computer program which consolidates information into one master location & variable database, matching information by its common row, such as zip or city. The computer program, in some embodiments, represents fetching and storing variables on the database.

In some embodiments, the present invention may use an API Gateway, Lambda Function and DynamoDB services provided by Amazon Web Services (AWS) to store different variables. The Target Location is the primary database table, and zip code is the primary key. The system stores all the zip code, respective city and state by fetching it from Google and/or USPS database.

Block 310 shows potential data available in static form from public or private databases, including but not limited to city names, utility company servicing area, area code, etc. Other database tables store variables specific to zip codes. The Static Variables database table consists of constant variables. For instance, Electric Utility provider/Area code for a zip code. Such information can be downloaded from government websites or publicly available data from the internet.

Block 320 shows potential data available in dynamic form via public or private databases, web scrapes or APIs, including but not limited to weather, etc. The Dynamic Variables database table directly connects to the weather API and store temperature (high/low) and weather conditions for a zip code (sunny, cloudy, rainy).

Block 330 shows potential data available in static or dynamic form via client databases, or public or private APIs, web scrapes, or a combination thereof, including but not limited to inventory, distance between, traffic between, etc. The Client Specific Variables database table directly connects with the client CRM to fetch variables specific to the client. For instance, inventory of goods and services provided by the client.

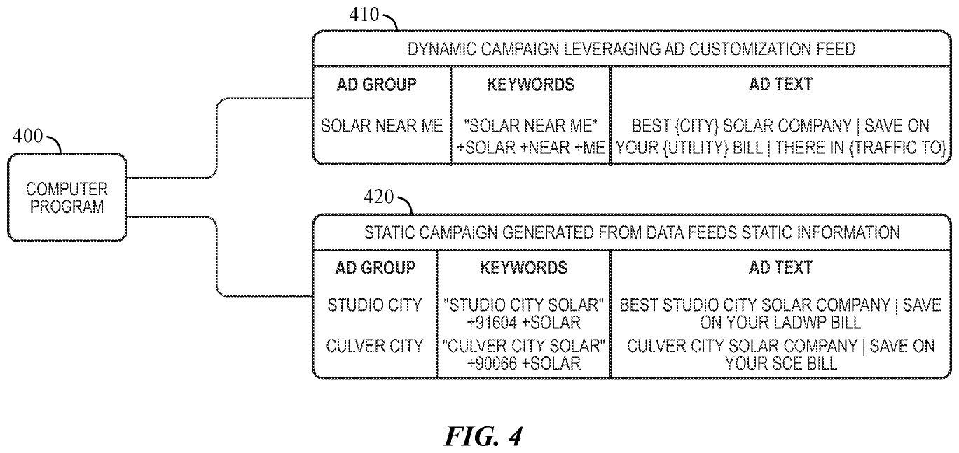

FIG. 4 illustrates a block diagram of the advertisement localization system. Block 400 shows a block diagram representing a computer program, which takes the above consolidated database from FIG. 3 described above, and generates both dynamic and static advertising campaigns and ad customizer data feeds, for advertising platform upload in their respective formats including but not limited to Google Ads, Microsoft Ads, Facebook Ads, etc.

In some embodiments, the computer program for the advertisement localization system represents a function of formatting an Ad Text. The program takes a list of advertising keywords ex. “[Solar Near Me, Plumber near Me]”, locations ex. “[Studio City, Culver City] and Formatter ex. “[+{}+{}, {} {}, [{} {}], Best {} Solar Company |Save On]” as inputs, where “{}” is the placeholder for City,Keyword etc. These inputs can be stored on a google sheet or cloud database.

The program uses Pandas Library from Python Programming Language to perform operations to output formatted Ad Text. Pandas is a fast, powerful library for data analysis and manipulation built in Python. Using Pandas, the system creates a list of variations of Ad text for a given keyword. For example, if the keyword is “Plumber” and Ad group (City in this case) is Lewisville. The variation specified of Ad text could be ‘+Lewisville+plumber′, ″Lewisville plumber′,[Lewisville plumber]′,+plumber+Lewisville′,″plumber Lewisville ′″,[plumber Lewisville]′,+plumber+75067′,+plumber+75056′,+plumber+75057′,+plumber+75077′,+plumber +75065′,+plumber+75029. In order to create a list of Ad text. The system uses the Apply, Map, lambda function of Pandas.

Block 410 shows an example of an advertising campaign structure for a search campaign, whereas the end advertisement includes dynamic variables which would be populated in real time from the ad customizer data feed, based on where the viewer was seeing from or searching for.

Block 420 shows an example of an advertising campaign structure for a search campaign, whereas the end advertisement includes static variables which would be pre-populated from the information database, based on where the viewer was seeing from or searching for.

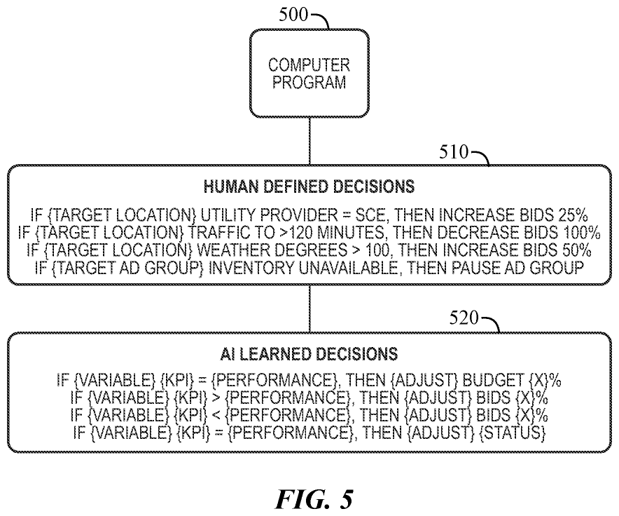

FIG. 5 illustrates a block diagram of the decision automation system. Block 500 shows a block diagram representing a computer program, which takes the above consolidated database from FIG. 3 described above and based on a set of rules. The computer program in block 500 represents a program which automatically increases or decreases advertising bids depending upon variables.

Block 510 shows a block diagram illustrating examples of potential input rules from humans, combining location data with variables to establish a set of rules. Block 520 shows a block diagram illustrating examples of potential learned decisions based on digested performance of variables by artificial intelligence (see Block 530), in addition to platform held KPIs based on location, to seek patterns and calculate adjustments based on information database's variable performance.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for localizing advertisements and automated decisions, the system comprising:
at least one user computing device in operable connection with a network;
an application server in operable communication with the user network, the application server configured to host an application program for providing a system localizing advertisements and automated decisions, the application program having a user interface module for providing access to the application program through the user computing device;
a first computer program to receive at least one of the following: one or more static variables, one or more dynamic variables, and one or more client specific variables; and
an advertisement localization system including a second computer program to interact with a dynamic campaign leveraging ad customization data feed and a static campaign generated from the static information; and
a decision automation system including a third computer program to receive one or more human defined decisions and one or more AI learned decisions.

2. The system of claim 1, wherein the one or more static variables are received from a public database.

3. The system of claim 1, wherein the one or more static variables are received from a private database.

4. The system of claim 1, wherein the one or more statis variables includes at least one of the following: a target location, a city name, an electrical utility, and an area code.

5. The system of claim 1, wherein the one or more dynamic variables includes a weather API.

6. The system of claim 1, wherein the one or more client specific variables includes at least one of the following: an inventory and a traffic data point.

7. A method for localizing advertisements and automated decisions, the method comprising the steps of:
receiving, via a first computer program, at least one of the following: one or more static variables, one or more dynamic variables, and one or more client specific variables;
localizing advertisements via a second computer program, the second computer program to interact with a dynamic campaign leveraging ad customization data and a static campaign generated from the static information; and
automating, via a third computer program, the reception of one or more human defined decisions and one or more AI learned decisions.

8. The method of claim 7, wherein the one or more static variables are received from a public database.

9. The system of claim 7, wherein the one or more static variables are received from a private database.

10. The system of claim 7, wherein the one or more statis variables includes at least one of the following: a target location, a city name, an electrical utility, and an area code.

11. The system of claim 7, wherein the one or more dynamic variables includes a weather API.

12. The system of claim 7, wherein the one or more client specific variables includes at least one of the following: an inventory and a traffic data point.
